(19) United States
(12) Patent Application Publication
(10) Pub. No.: US 2008/0203076 A1
(43) Pub. Date: Aug. 28, 2008

(54) Method and Apparatus for Heating an Object

(76) Inventor: Daniel Gelbart, Vancouver (CA)

Correspondence Address: EASTMAN KODAK COMPANY;PATENT LEGAL STAFF, 343 STATE STREET, ROCHESTER, NY, 14650-2201, US

(21) Appl. No.: 11/816,417

(22) PCT Filed: Feb. 18, 2005
(86) PCT No.: PCT/CA05/00207

§ 371 Date: Aug. 16, 2007

(51) Int. Cl. H05B 1/00

(52) U.S. Cl. 219/201

(57) ABSTRACT

Rapid heating of a surface of an object is achieved by moving the surface of the object proximate to one or more flexible baffles. The one or more flexible baffles are in fluid communication with a pressurized and heated flow of air. The one or more baffles are arranged to contact the surface of the object in the absence of the flow of air. The flow of air creates a gap between the one or more flexible baffles and the adjacent portions of the surface. The flow of air traveling through the gap heats these portions of the surface with a high thermal transfer efficiency. Objects to be heated may include substantially two-dimensional planar objects such as thin plates, as well as three-dimensional objects such as cylinders.

### TECHNICAL FIELD

The invention pertains to the field of heating objects and, in particular, to heaters for rapidly heating substantially two dimensional planar objects such as printing plates and three dimensional objects such as printing cylinders.

### BACKGROUND

Printing operations undertaken in an offset printing press typically use lithographic printing plates. Lithographic printing plates are produced in a process involving the exposure of an image onto a plate substrate. The plate substrate typically comprises a thin aluminum alloy sheet suitably treated so as to be sensitive to light or heat radiation.

One process for making a lithographic plate suitable for use on an offset printing press employs a film mask. Such masks are typically produced by exposing highly sensitive film media using low power laser printers known as “image-setters”. The film media is usually processed in some manner and is then placed in area contact with a photosensitive lithographic plate which is, in turn, “flood” or “area” exposed through the film mask. Such plates are referred to herein as “conventional” printing plates. The most common conventional printing plates used in such a process are sensitive to radiation in the ultraviolet region of the light spectrum. It is typically necessary to amplify the difference between the exposed and un-exposed areas in a further chemical processing step that removes the unwanted coating and converts the plate into a lithographic printing surface ready for use on a printing press.

More recently, a method of exposing lithographic printing plates directly through the use of specialized printers known as plate-setters has gained popularity. A plate-setter in combination with a computer system that receives and conditions image data for sending to the plate-setter is commonly known as a Computer-to-Plate or “CTP” system. CTP systems offer a substantial advantage over image-setters in that they eliminate the film mask and the associated process variation associated with that extra step. The CTP system receives the image data and formats it to make it suitable for outputting to an exposure head within the plate-setter. The exposure head in turn controls a radiation source, which is typically a laser, to image picture elements (pixels) on the lithographic plate according to the image data.

Lithographic printing plates imaged by CTP systems are typically referred to as “digital” printing plates. The radiation beams emitted by the exposure head induce a physical or chemical change in a coating on the digital plates. Most digital plates comprise either high-sensitivity photopolymer coatings (“visible light plates”) or thermal coatings (“thermal” plates). Visible light plates are typically exposed by a blue-violet laser diode of 10-100 mW. High power IR lasers in the range of 1 W to 100 W are used to expose thermal digital plates.

Like lithographic printing plates produced using film-based methods, many types of exposed or imaged digital printing plates typically undergo a further chemical processing step that removes the unwanted coating and converts the plate into a lithographic printing surface ready for use on the press.

Regardless of the method employed to image or expose a lithographic printing plate, the exposed printing plate is often pre-heated or pre-baked in an oven prior to being washed in a chemical solution during the subsequent chemical processing step. Additionally the processed printing plate can also be post-baked in another oven after the chemical processing step.

Once exposed or imaged, the printing plate typically undergoes the pre-heat step so as to render image-wise exposed areas of the printing plate insoluble in the subsequent chemical development or processing steps. Un-exposed areas of the printing plate remain soluble and are washed away in the chemical baths to produce a final printing plate with the necessary differentiation between print areas and non-print areas. Typically, when the printing plates are exposed in a CTP plate-setter and then undergo this pre-heat step, the printing plates are referred to as “negative” or “negative-working” plates. Negative plates that are exposed with the use of conventional film masks are characterized such that the desired “printing image” will be exposed during the subsequent flood exposure. Likewise, negative plates that are imaged by a CTP system are characterized such that the desired “printing image” is imaged by the CTP plate-setter itself. In this context, the term “printing image” refers to the image that ultimately is printed on the press. In either case, the printing image exposed on the printing plate is made insoluble by the pre-heat step such that it remains intact after the subsequent processing step.

“Positive”, or “positive working” plates are essentially the opposite of negative plates. The background image or the non-printing image is directly exposed onto positive plates. Exposed positive plates typically do not undergo a pre-heat step. In fact, the exposed background images are rendered soluble upon exposure. Consequently, a positive plate can be chemically processed such that the exposed or imaged background is washed away to produce a final printing plate that comprises the necessary print image required on press.

Post-baking of a processed printing plate is usually conducted to impart specific characteristics to the printing plate. Such characteristics can include increasing plate life on press. Some plate manufacturers claim that plate life can be increased as much as five-fold by post-baking. Different criteria can be used to determine when a plate has reached its end-of-life. One such criteria suggests that a plate has reached its end-of-life when more than 25% of 200 lpi 1% dots imaged on the plate are worn off during printing (as determined visually). The benefits of post-baking are not limited to any one type of plate. Conventional and digital plates can be post-baked in accordance with their respective manufacturer's instructions.

Pre-heat and post-bake ovens have typically been conveyor ovens. Conveyor ovens are disclosed by Strand in U.S. Pat. No. 6,323,462.

Conveyor ovens typically need to be kept on all the time since their warm-up time is lengthy. Conveyor ovens are typically very large in size and thus have substantial space requirements. These space requirements are exacerbated when a processing line requires both pre-heat and post-bake capability. Consistent and uniform oven temperatures have a significant effect on the quality of the processed plate, thus further increasing the complexity of conveyor ovens which often include numerous blowers, heating elements and extensive ductwork. Ovens that comprise inductive heating systems (also known as RF heating) or microwave heating systems can offer instant warm up, but are expensive since they require many kilowatts of power at high frequencies.

A pressurized air bearing (also known as an aerostatic bearing) is similar to any pressurized fluid bearing, except the fluid is air. Like hydrostatic bearings, pressurized air bearings have a porous or perforated plate, known as a bearing pad, through which pressurized air is allowed to escape. The pressurized air prevents contact between the pad and a moving object. The bearing pads can incorporate any air-permeable arrangement and include uniform and distinctly shaped openings or randomly formed openings such as the openings in sintered plates. An air bearing can be single or double sided. In the latter embodiment, the object glides between two parallel pads without touching either one and with practically no friction.

Air bearings are capable of exhibiting exceptionally fast heat transfer to a planar object such as a printing plate. In regular convection ovens most of the heated air bypasses the printing plate, therefore heat transfer efficiency is low. In a heated air-bearing oven, most of the heated air can be forced to flow through a relatively small parallel gap between the printing plate and the bearing pads, thereby resulting in very good heat transfer. Another advantage is that such a heated air bearing oven can be compact and has low thermal mass since there is no requirement to heat up a large enclosure.

Devices incorporating heated air bearings to heat printing plates are described in Oelbrandt et al., EP 0 864 944 A1. Oelbrandt et al. disclose an air bearing device that comprises two planar air bearing plates used to heat an imaging element that can include various forms of paper, film, plastics, laminates and printing plates. Oelbrandt et al. disclose that the spacing between the two air bearing plates is in the range of 2 to 20 mm and that hot air is applied to both sides of an imaging element within this spacing to provide substantially equal flows at substantially equal air temperatures on either side of the imaging element.

In U.S. Pat. No. 5,181,329, Devaney, Jr. et al. disclose an apparatus for drying conventional film and paper during a photo processing operation. Devaney, Jr. et al. describe drying a web of paper or film between a pair of spaced, parallel air bearing members having flat surfaces defining a channel through which heated air is used to support the web. In addition to the air bearing air inlet holes, air bearing evacuation holes are provided at a predetermined distance from the inlet holes so as to maintain the heat transfer rate in the channel higher than the heat transfer rate in the web.

Differential thermal expansion effects can cause planar objects such as metal and polyester printing plates to distort and buckle when such objects are conveyed through an air-bearing oven. The amount of distortion will depend on a cross-sectional geometry of the object as well as its material properties. Specifically, the leading edge portion of the plate tends to expand when it enters a heated air-bearing oven from ambient conditions. However, the remaining portion of the plate that has not entered the heated air bearing does not expand since it is still exposed to ambient air temperatures. The heated leading edge portion of the plate is thus constrained from expanding freely. Consequently the leading edge portion of the plate may buckle and may strike one or both of the air-bearing pads. Any imaged or exposed coating on the printing plate may be damaged. This can result in undesirable on-press printing artifacts.

Prior art air-bearing heating devices have tried to overcome these difficulties by spacing the planar air bearing pads further apart to produce a large “air-bearing gap” or “gap”. Although this may prevent damage to the planar object, the thermal transfer efficiency of the heated air-bearing is reduced. For a typical printing plate having a thickness of 0.3 mm, it has been shown that the greatest thermal heat transfer occurs when the air-bearing gap is under 1 mm, or approximately three times the thickness of the plate. Increasing the air bearing gap to 2 mm reduces the thermal transfer efficiency by approximately 30% to 50%. Gaps in the 10 to 20 mm range substantially limit the air bearing thermal transfer.

Various heating systems have been employed in the prior art to directly heat the surfaces of rolls or cylinders or the surface of a web material supported on such a cylinder. These systems typically used convection heaters, radiation heaters, conduction heaters or a combination of the two or more of the three. With convection heating, a gas (typically air) is heated to a desired temperature and blown on the surface of the rolls (or substrate supported thereon). The amount of heat transfer is dependant on both the velocity and the attack angle of the air being blown onto the surface to be heated. The efficiency of such systems is somewhat limited since the air quickly escapes upon impinging the surface. Radiation heating requires a line of sight between the heater and the object to be heated, and the heat transfer occurs by the directing of electromagnetic waves at the object. As previously described, radiation heating is costly and consumes a great deal of power.

Another method of applying heat to the surface of the roll or supported web is through the use of conduction. When heating a web of material, this is usually accomplished by advancing the web about a thermally conductive roll. A hot fluid such as oil or steam is injected into the roll. The roll in turn conducts the heat to the supported web. Conduction heating systems are complex and costly to produce and operate since the roll must be designed to support the heated fluid as well as maintain the temperature of the fluid. In U.S. Pat. No. 6,733,284, Butsch et al. describe the use of a heated belt wrapped in intimate contact with at least a portion of the roll or a web of material supported thereon. The belt is an endless belt that continuously moves in relation to the rotating surface of the roll or web. Heat is transferred by conduction from portions of the belt that are in contact with respective portions of the roll or web. Because of the contact involved between the belt and the surface to be heated, this system may not be suitable for rolls or webs comprising delicate surfaces.

There remains a need for practical and cost-effective heating devices capable of heating the surfaces of planar objects such as printing plates. Such heating devices should be capable of a rapid warm up, so that the heating devices can be kept off and turned on only when needed. Further, an oven incorporating such a heating device should ideally be compact and have a high thermal efficiency approaching that of a heated air-bearing oven.

There is a particular need for simple heating devices that can be used to heat either the surfaces of three-dimensional objects such as rolls and cylinders or webs of planar material supported on such rolls or cylinders. Such heating devices should preferably be compact and have thermal efficiencies approaching that of heated air-bearing ovens. Such heating devices should minimize contact with the surfaces of the objects to be heated, especially when the object is a lithographic printing plate or a roll that is coated with a photopolymer or thermal photosensitive coating.

### SUMMARY OF THE INVENTION

A first aspect of the invention provides methods for heating a first surface of an object. The methods comprise moving the first surface proximate to at least a first flexible baffle that is in fluid communication with a first portion of a pressurized and heated flow of air. The flexible baffle is arranged to contact the first surface in the absence of the flow of air. The method further comprises creating a gap between the flexible baffle and a portion of the first surface with the first portion of the flow of air and heating the portion of the first surface with the first portion of the flow of air. The method may further provide for heating a second surface of the object. The second surface is moved proximate to at least one second flexible baffle wherein the second flexible baffle is in fluid communication with a second portion of the pressurized and heated flow of air. The second flexible baffle is arranged to contact the second surface in the absence of the flow of air. The method further comprises creating a gap between the at least a second flexible baffle and a portion of the second surface with the second portion of the flow of air and heating the portion of the second surface with the second portion of the flow of air.

The methods may further comprise supporting the object while moving the first surface. The method may also comprise moving the first surface along a substantially linear path or a substantially curved path. The method can also comprise heating the first surface with a plurality of flexible baffles, wherein one of the flexible baffles is configured to be longer than another of the flexible baffles. The method can also comprise recirculating and filtering the air.

Another aspect of the invention provides apparatus for heating a first surface of an object. The apparatus comprises means for moving the first surface of an object proximate to at least a first flexible baffle, wherein the first flexible baffle is in fluid communication with a first portion of a flow of air and wherein the first flexible baffle is arranged to contact the first surface in the absence of the flow of air. The apparatus also comprises an air circulation means operable for creating and pressurizing the flow of air, and an air heating means operable for heating the flow of air. At least a first plenum conveys the first portion of the flow of air to the first flexible baffle to create a gap between the first flexible baffle and a portion of the first surface, and to heat the portion of the first surface with the first portion of the flow of air. The apparatus may also include a second flexible baffle that is in fluid communication with a second portion of the flow of air and is arranged to contact the second surface in the absence of the flow of air. A second plenum conveys the second portion of the flow of air to the second flexible baffle to create a gap between the second flexible baffle and a portion of the second surface, and to heat the portion of the second surface with the at least a second portion of the flow of air.

Apparatus according to some embodiments of the invention comprises a first plurality of flexible baffles. A first one of the first plurality of flexible baffles is longer than another one of the first plurality of flexible baffles. The first flexible baffle comprises first and second ends. Both ends are secured to a surface adjacent the first surface. The apparatus may also comprise a support means for supporting the object as its surface is moved proximate to the first flexible baffle. In some embodiments, the apparatus comprises a third plenum operable for recirculating the flow of air. In some embodiments, the object is a planar object or a cylindrical object.

Further aspects of the invention and features of embodiments of the invention are set out below.

### BRIEF DESCRIPTION OF DRAWINGS

In drawings which illustrate, by way of example only, embodiments of the invention:

FIG. 1 is an isometric view of an oven according to an embodiment of the invention;

FIG. 2 is a cross-sectional view in direction A-A of the oven shown in FIG. 1;

FIG. 3 is a cross-sectional view in direction B-B of the oven shown in FIG. 1;

FIG. 4 is an enlarged cross-sectional view of the oven of FIG. 1;

FIG. 5 is a cross-sectional view of an oven according to another embodiment of the invention;

FIG. 6 is a cross-sectional view of an oven according to another embodiment of the invention;

FIG. 7 is a cross-sectional view of an oven according to another embodiment of the invention used to heat a rotating cylinder; and

FIG. 8 is a cross-sectional view of an oven according to yet another embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

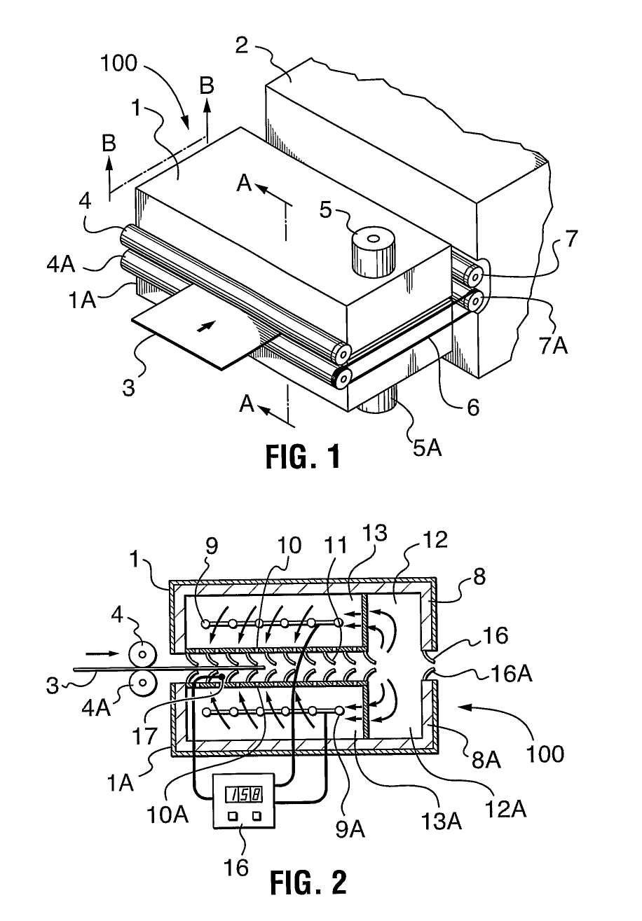

FIG. 1 shows an oven 100 comprising two substantially identical heating assemblies 1 and 1A. In other embodiments of the invention, heating assemblies 1 and 1A may differ from each other. An object 3 may comprise any media that is to be heated and can include, but is not limited to, various forms of paper, film, plastics, laminates and printing plates.

Object 3 is substantially planar and is fed into oven 100 by an object moving means comprising drive rollers 4 and 4A. Since drive rollers 4 and 4A contact both planar surfaces of object 3, the nip pressure between drive rollers 4 and 4A and object 3 should be chosen to minimize the potential for damaging any exposed or imaged coated planar surface of object 3. Other appropriate object moving means are known in the art, and may be employed in place of drive rollers 4 and 4A. For example, object 3 may be carried on a suitable conveyor. Where object 3 is carried on a conveyor it is possible to avoid contact with any coated surface of object 10. Alternatively, object 3 may comprise a web of material that is drawn through oven 100, by an object moving means that comprises any suitable web transporting mechanism known in the art. The object moving means moves object 3 proximate to a plurality of flexible baffles 11 within each of heating assemblies 1 and 1A.

In an embodiment wherein oven 100 is a pre-heat oven, heating assemblies 1 and 1A may be coupled to a plate processor 2, located downstream of oven 100. Drive rollers 4 and 4A may be synchronized to in-feed rollers 7 and 7A of the plate processor via a timing belt 6 or any other means of synchronization. Due to the elevated temperatures involved, it is desired to make rollers 4, 4A, 7 and 7A from a material such as a silicone rubber, which can operate in these environments. It is understood that in other embodiments of the invention, plate processor 2 may comprise any other piece of equipment that the object is introduced into in a synchronous fashion. Alternatively, in still other embodiments of the invention, oven 100 is additionally, or solely synchronously coupled to a piece of equipment upstream of the oven. In still other embodiments of the invention, oven 100 is not synchronously coupled to any other equipment.

Oven 100 comprises an air circulation means, which in the embodiment of FIG. 1, is located in each of the heating assemblies 1 and 1A. The air circulation means is operable for generating and pressurizing a flow of air. In this embodiment of the invention, the air circulation means comprises a circulation fan 14. Suitable circulation fans are widely used in household ovens of the type known as convection ovens and need not be explained further. Circulation fan 14 is located inside heating assembly 1 and is driven by motor 5 which is preferably located outside oven 100 in order to be protected from the heat. The shaft connecting motor 5 to circulation fan 14 may be provided with cooling discs (not shown) if desired. Cooling discs may be made of a good heat conductor, such as aluminum, and mounted on the rotating shaft to dissipate heat conducted along the shaft from inside oven 100. In this embodiment of the invention, heating assembly 1A is identical to heating assembly 1, and thus accordingly comprises its own air circulation means comprising motor 5A and a circulation fan (not shown). In other embodiments of the invention, a single air circulation means may be employed for heating assemblies on two sides of an object to be heated.

To conserve energy, the air circulation means can recirculate hot air. Recirculating the hot air after it has passed across object 3 will further increase thermal transfer efficiency. Other advantages of air recirculation include avoiding heating up surrounding objects due to escaping hot air, and the ability to trap or destroy any volatile emissions emanating from the heated object. Filters (not shown) preferably positioned upstream of circulating fan 14 may be employed to trap liquids or volatile compounds entrained in the circulating air. Further, any air heating means employed can additionally include a catalytic converter (not shown, but similar in concept to the catalytic converters used in motor vehicles) to decompose organic compounds into simple gases such as CO₂, NO₂ and water vapour. Providing such a catalytic converter can reduce or prevent organic deposits in the system. Although air recirculation has many benefits, some embodiments of the invention do not include air recirculation systems.

FIG. 2 is a cross section of oven 100 along the direction A-A shown in FIG. 1. Each of heating assemblies 1 and 1A comprise one of thermally insulated housings 8 and 8A, and an air heating means. The air heating means comprises, for example, electrical heating elements 9 and 9A. Oven 100 preferably further comprises a temperature controller 16 having a sensor 17 measuring the air temperature between the heating assemblies 1 and 1A. Temperature controllers for electric ovens are well known in the art and examples are commercially available from Omega Corporation (www.omega.com). Sensor 17 preferably comprises a fast responding thermocouple sensor.

Power is supplied at least to both the temperature controller 16 and the air circulation means. Further, this power can be switched so that it is supplied only when needed. Oven 100 is only required to be in a “heating mode” in which a heated airflow at desired temperature and pressure conditions is provided when an object 3 is available to be heated. This mode of operation would require an oven warm-up time measured typically in the range of about 5 minutes. Taking into account this warm-up time and the feed rate of the feed mechanism, power is accordingly provided when the object 3 has reached some predetermined position prior to reaching oven 100. Any contact or contact-less sensor (not shown) can be used to determine when object 100 is at the predetermined position and thus engage the power to place oven 100 in its heating mode.

In heating assembly 1 of the oven shown in FIG. 2, air is heated in plenum 13 and passes via small holes 10 which are in fluid communication with the space surrounding flexible baffles 11. Plenum 13 is operable to achieve a uniform air pressure (and uniform flow) before the air passes on to heat object 3. After passing through holes 10, the air passes between flexible baffles 11 and object 3 (or just between flexible baffles 11 if no object is present) and into the plenum 12 for recirculation. Heating assembly 1A operates similarly.

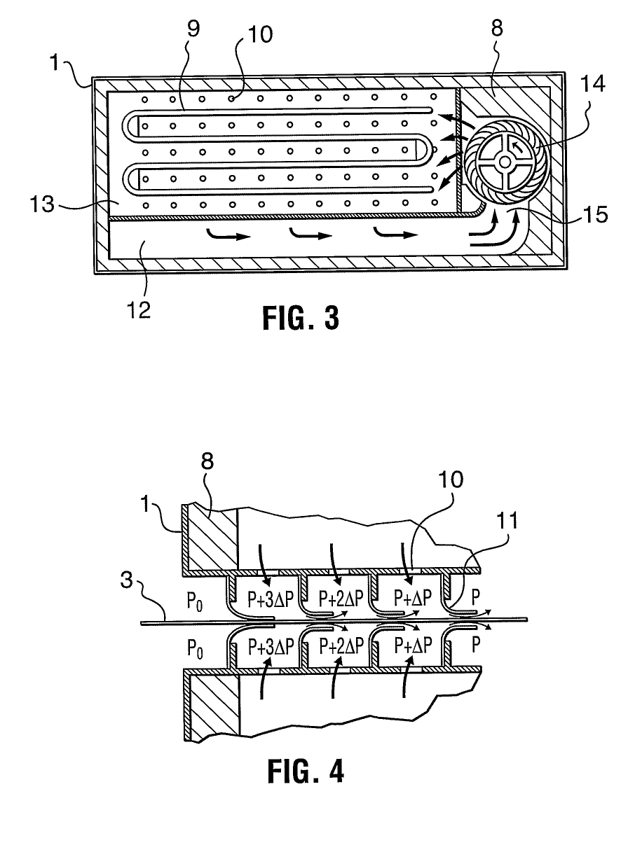

Referring now to FIG. 3, air from plenum 12 is drawn into circulation fan 14 (driven by motor 5 shown in FIG. 1). Plenum 12 is arranged to lead into the intake zone of circulation fan 14 (located under the circulation fan wheel). From circulation fan 14, air is fed into plenum 13 where it is heated by heater elements 9 and exits via holes 10. A pair of flexible exit seals 16 and 16A are located at the exit of oven 100 to minimize airflow losses from plenums 12 and 12A, and to improve the heat transfer efficiency of the oven 100. Depending on the airflow condition adjacent to exit seals 16 and 16A, they may or may not contact object 3 as it exits oven 100. Exit seals 16 and 16A as well as any entrance seals employed may be constructed from suitable rubber, polymers or other sealing materials suitable for the associated temperatures. One or both of seals 16, 16A may have a brush-like construction in which the seal comprises many individual bristles.

As shown in FIG. 4, heating assemblies 1 and 1A each comprise flexible baffles 11. The flexible baffles 11 are preferably constructed from a PTFE impregnated glass fabric approximately 0.1-0.2 mm thick. However, any other heat resistant thin flexible material can be used, such as metal baffle, foils, fiberglass cloth, polyimide such as DuPont Kapton™, and pure PTFE such as DuPont Teflon™, etc. Flexible baffles 11 inherently comprise a shape or are oriented such that their distal portions point in a direction of travel of object 3 within oven 100. In the absence of any airflow in either of heating assemblies 1 and 1A, the heating assemblies are preferably arranged such that distal end parts of their respective flexible baffles 11 contact each other in the space 18 between the two heating assemblies with some overlap of approximately 5 to 50 mm. The pairs of opposed flexible baffles may be arranged to provide an initial small gap between corresponding pairs of flexible baffles, but each of the flexible baffles preferably projects into space 18 sufficiently to be in contact with a corresponding surface of object 3, in the absence of any airflow. It is possible to arrange flexible baffles 11 to create an initial small gap between the baffles and corresponding surfaces of object 3 in the absence of any airflow, but at a cost of reduced heart transfer efficiency during the operation of oven 100. Additionally, heating assemblies 1 and 1A should be further arranged such that the spacing formed therebetween is greater than any heat induced distorted form of object 3.

Air from holes 10 and 10A pressurizes each of the chambers 19 between adjacent ones of flexible baffles 11. If the pressure inside any given chamber 19 is higher than the pressure outside of the given chamber, the flexible baffles 11 defining the given chamber 19 will flex due to their flexible nature to let some air escape. Since the last chamber 19 is connected to the recirculation plenum 12 that is in turn connected to the low-pressure side of circulation fan 13, a pressure gradient develops along chambers 19 as shown in FIG. 4. This pressure gradient ensures that the first set of contacting flexible baffles 11 at the entrance of oven 100 (the leftmost contacting baffles in FIG. 4) will stay in contact with object 3, while baffles 11 downstream from the entrance will be separated from object 3 by a layer of air. The contacting flexible baffles 11 (i.e. at least the set at the entrance of oven 100) should be constructed from a suitable material and should be arranged to minimize the contact pressures therebetween so as to not damage any sensitive surface of object 3. Some suitable materials for baffles 11 are described above.

In all of the remaining sets of contacting flexible baffles 11, a gap will be formed therebetween regardless of whether object 3 is present or not. Flexible baffles 11 are preferably constructed from a uniform and non-porous material that allows the pressure gradient to develop. A flexible baffle comprising a porous material is possible, but the level of porosity should be low enough to allow the pressure gradient across the flexible baffle to be established. In all cases, the stiffness of the flexible baffles 11 is chosen such that the gap can be created in response to the air pressures employed. When the object 3 is present, a thin gap will exist between each of the flexible baffles 11 and a surface of the object 3. A very thin layer of air will be established in each of these thin gaps. Each of these very thin layers of air is a very efficient heat exchanger, since almost all the related airflow is passing very close to the surface of object 3.

Surprisingly, this arrangement can provide a heat transfer efficiency similar to that of a heated air-bearing comprising closely spaced air-bearing surfaces. Unlike prior art heated air-bearing systems that require relatively large air bearing gaps (i.e. at a cost of reduced heat transfer efficiency) to avoid damaging a planar object that has been distorted by heating, preferred embodiments of this invention are not sensitive to these heat induced distortions in the object, since the flexible baffles 11 simply flex and follow distortions in the object.

The gap and associated thin layer of air will be maintained between the flexible baffles 11 and a corresponding surface of object 3, even if object distorts as it is moved proximate to the flexible baffles 11. This is due to the Bernoulli effect created by the airflow within each of the thin gaps established between the flexible baffles 11 and the corresponding surface of object 3. Specifically, a low-pressure zone will be created between the surface of the flexible baffle 11 and the corresponding adjacent surface of the object 3, due to the velocity of the airflow therebetween. This low-pressure zone will be less than the pressure on the opposing surface of flexible baffle 11 (i.e. the surface of flexible baffle 11 nearest to holes 10). The resulting pressure differential will cause the flexible baffle 13 to conform to the distorted surface of object 3, while still maintaining the same gap throughout. Since the gap is maintained throughout regardless of any distortion of the planar object, the corresponding heat transfer efficiencies will also be maintained. Heat assemblies 1 and 1A can be said to form a “compliant” or “baffled” heated air-bearing.

In some embodiments, the air circulating means (circulating fan 14 in the embodiment of the invention shown in FIGS. 1 to 4), is operable to create an air pressure of about 20 mbar when the oven is in its heating mode. A pressure working range from 5 mbar to over 500 mbar has provided satisfactory results.

Circulating fan 14 is further operable to create the desired airflow conditions. The desired airflow will depend on, among other things, the size of the objects to be heated as well as the rate at which objects need to be heated. For continuous feeding of 0.3 mm thick aluminum printing plates, an airflow of approximately 20 liters/sec per meter width of plate was found suitable (i.e. corresponding oven temperatures of 100 deg C. to 250 deg C.) when 3 KW to 5 KW air heater elements 9 were used. The length of each of heating assemblies 1 and 1A (i.e. the length along the direction of travel of the object) is chosen to allow any portion of the object 3 to spend at least a few seconds between the two heating assemblies. In one specific embodiment tested, the plate feed rate was 1 meter/min and the length of the heating assemblies was 15 cm, producing a heating “dwell time” of about 10 seconds. Heating dwell times as short as 2 seconds have been tested successfully.

In another embodiment of the invention, the airflow created by circulating fan 14 is kept at a very low level when the oven 100 is not in use while the air temperature is continuously maintained at its “heating mode” operating level. Because of the low airflow, power consumption can be low as well. Typical airflow requirements in this embodiment of the invention are approximately 10% of the levels required during actual heating of the object (i.e. 2 liters/sec as opposed to a 20 liters/sec heating mode value), and the actual power consumption in this mode is about 20% of normal for a well-insulated oven. In this embodiment of the invention, when object 3 is sensed or detected, circulating fan 14 increases the airflow to its heating mode value. Because the air heating means is already at the necessary heating temperature, warm up is achieved very quickly, typically in well under 10 seconds. A suitable systems controller can be used to control the operation of the object moving means, the air circulation means and the air heating means to control the warm-up time and operating heating conditions of any of the preferred embodiments of the invention.

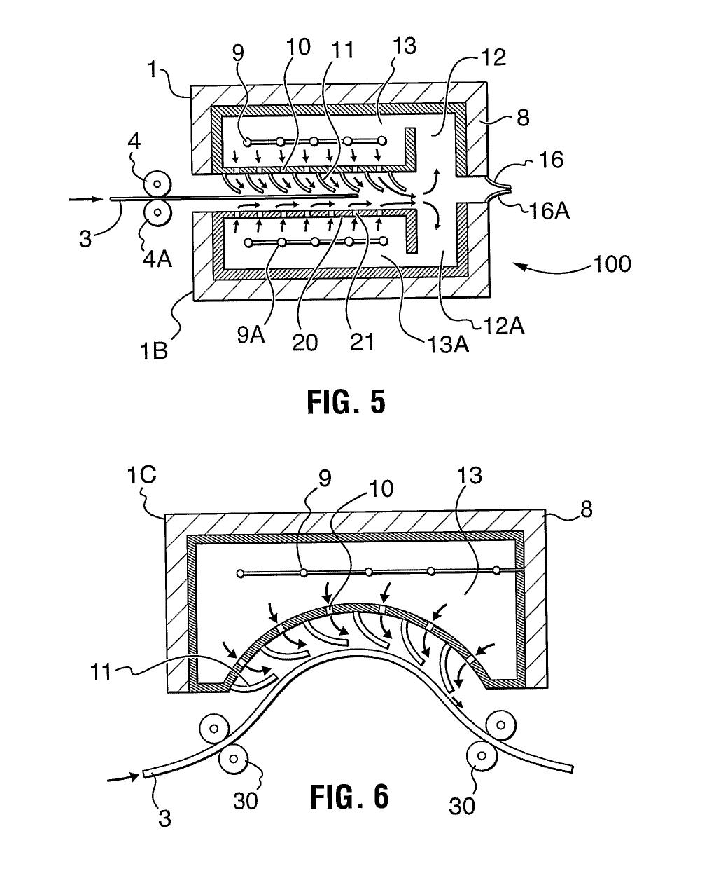

FIG. 5 shows an oven 100 wherein only heating assembly 1 is employed. Oven 100 further comprises a heating assembly 1B comprising a plenum 13 in fluid communication with a plurality of openings 21 of planar air-bearing plate 20. A circulation fan (not shown) is operable for forcing air through plenum 12A into plenum 13A. Heating element 9A is operable for heating the air that is then forced through openings 21 of air bearing plate 20. Heating assemblies 1 and 1B are preferably arranged such that in the absence of any airflow in both heating assembly 1 and 1B, the flexible baffles 11 of heating assembly 1 contact air-bearing plate 20. Alternatively, the flexible baffles 11 of heating assembly 1 may be arranged to contact a corresponding surface of object 3 in the absence of airflow.

The principles of heat transfer described above in relation to FIGS. 1 to 4 also apply to the heating assembly 1 of FIG. 5. The heating assembly 1B will have a heat transfer efficiency associated with the “air bearing gap” that forms between air-bearing 20 and the adjacent surface of object 3. By balancing the respective airflows into each of the heating assemblies 1 and 1B, the air-bearing gap may be reduced to a sufficiently small value to maintain a heat transfer efficiency comparable to that of heating assembly 1. However, if object 3 undergoes thermally induced distortion, this reduced air-bearing gap may result in an undesirable contact of object 3 with the air-bearing plate 20. If object 3 has a single sensitive surface (e.g. coated side of a printing plate), it may be desirable to orient object 3 such that its sensitive surface faces heating assembly 1.

Flexible baffles 11 need not be arranged in a substantially planar manner as shown in the embodiments of the invention represented in FIGS. 1 to 5. Object 3 being a planar object in these embodiments may be bent by a suitable bending means so as to follow a curved path proximate the plurality of flexible baffles 11. Bending means can comprise but are not limited to a series of pinch rolls 30 that can bend the planar object into a desired curve. Obviously, a planar object may also be bent around one or more rolls. Bending planar object 3 advantageously stiffens it to help counter heat induced thermal distortions.

FIG. 6 shows an embodiment of the invention wherein the object 3 is conveyed through a curved path proximate to a plurality of flexible baffles 11 of a heating assembly 1C. The flexible baffles 11 of heating assembly 1C are arranged to substantially match the curvature of the curved path. Flexible baffles 11 are arranged to contact the bent planar object 3 in the absence of airflow in heating assembly 1C. As in previous embodiments of the invention, a pressurized airflow is heated by heating element 9 in plenum 13, and enters via holes 10 into chambers formed by the flexible baffles 11. Heat transfer occurs within the small gaps that form between the flexible baffles 11 and the corresponding adjacent surface of object 3.

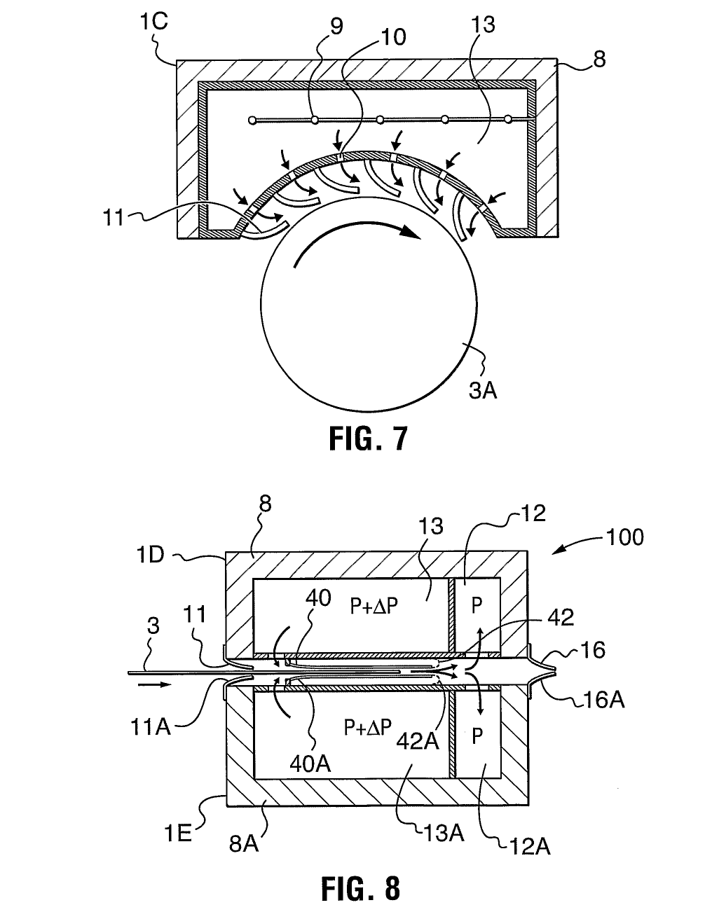

It will be readily evident that the applicability of the invention is not limited to substantially two-dimensional planar objects. The invention can also work on the surfaces of non-planar three-dimensional objects such as rotating cylinders. FIG. 7 shows an object 3A that comprises a rotating cylinder, whose surface is rotated proximate to the plurality of flexible baffles of heating assembly 1C. Object 3A may comprise different types of rotating cylinders including, but not limited to: rolls, printing cylinders and drums, and printing sleeves. Printing cylinders can include but are not limited to offset, gravure, flexographic and letterpress printing cylinders. Printing sleeves can include but are not limited to offset, gravure, flexographic and letterpress printing sleeves. Rolls can include any rolls requiring heating in any industrial applications including but not limited to printing presses, and paper and plastic handling machinery. Additionally, a planar object such as a printing plate may be attached to a three dimensional forme such as a cylinder or sleeve and have its surfaces heated by an embodiment of the invention. Flexible baffles 11 may be arranged as described in other embodiments of the invention. Heat transfer occurs within the small gaps that form between the flexible baffles 11 and the surface of rotating object 3A.

FIG. 8 shows an oven 100 according to yet another embodiment of the invention. Oven 100 comprises two substantially equivalent heating assemblies 1D and 1E. Heating assemblies 1D and 1E are comparable to heating assembly 1 (shown in FIG. 1) in that they each comprise similar plenums 12 and 13, exit seals 16 and 16A, as well as similar air circulation means (not shown) and air heating means (not shown). Heating assemblies 1D and 1E differ in their heating baffle configuration. Flexible baffles 11 and 11A are still located at the entrance of oven 100. As in previous embodiments of the invention, these “entrance” flexible baffles may contact object 3 throughout its travel through oven 100. However, unlike some of the previously disclosed embodiments of the invention, each of heating assembly 1D and 1E respectively comprise a single long flexible baffle 40 and 40A instead of an inboard plurality of flexible baffles. Flexible baffles 40 and 40A preferably comprise the same materials as previously described for flexible baffles 11 and 11A. Flexible baffles 40 and 40A may be much longer than flexible baffles 11 and 11A and their lengths are primarily determined in accordance with the time that a given portion of the object 3 is desired to spend between flexible baffles 40 and 40A to ensure adequate heat transfer. In the example described earlier, with a heating assembly length of 15 cm in the travel direction of object 3, baffles 40 and 40A that were about 10 cm long were successfully employed. Flexible baffles 40 and 40A inherently comprise a shape or are oriented such that they are substantially aligned with the travel direction of object 3 within oven 100. Further, in the absence of any airflow in either of heating assemblies 1D and 1E, the heating assemblies are preferably arranged such that their respective flexible baffles pairs 11, 11A, and 40, 40A contact each other in the space created between the two heating assemblies, or alternately contact the corresponding adjacent surfaces of object 3. A small gap may be permitted between flexible baffles 40 and 40A at a cost of lower heat transfer efficiency.

A single pressurized chamber is formed between flexible baffles 11, 11A, 40 and 40A. Since this pressurized chamber is connected to the recirculation plenums 12 and 12A that are in turn connected to the low-pressure side of the air circulation means, a pressure gradient develops where a gap is formed between flexible baffles 40 and 40A regardless of whether object 3 is present or not. When the object 3 is present, a thin gap will exist between the each of the flexible baffles 40 and 40A and a corresponding surface of the object 3. Once again, a very thin layer of air will be established in each of these thin gaps. Consequently, once the air heating means heats the upstream air, the very thin layer of air will lead to very effective heat transfer between flexible baffles 40 and 40A and the surfaces of object 3, as previously described. Flexible baffles 40 and 40A may be prone to chattering or fluttering under some conditions due to their length. Accordingly, in some embodiments of the invention, the downstream ends of flexible baffles 40 and 40A may be secured as respectively represented by ghosted lines 42 and 42A. In these embodiments of the invention, the enclosed volumes created by the additionally secured flexible baffles 40 and 40A are preferably vented to a low-pressure regions such as plenum 12 and 12A.

It should be noted that in the embodiments of the invention disclosed above, a pressure chamber created by plurality of flexible baffles has been employed to create a pressure differential across a given flexible baffle. This pressure differential causes the given flexible baffle to create the gap between it and the adjacent surface of the object resulting in the heat transfer benefits of the invention. In other embodiments of the invention, these pressure chambers may be created by the given flexible baffle and one or more additional seals which are not equivalent in form shape or construction to the given flexible baffle (e.g. standard rubber and/or polymeric seals suitable for the associated temperatures). Alternatively, other embodiments of the invention may not employ a pressure chamber but use other pressurization means to create a pressure differential across a given flexible baffle such as flexible baffle 40 in FIG. 8. Such pressurization means can comprise the direct injection of high-pressure air at the upstream junction of a given flexible baffle and the adjacent surface of the object to be heated.

By the way of example, the an experimental oven similar to the embodiment of the invention shown in FIGS. 1 to 4 was created from two heating assemblies comprising flexible baffles that were made of 0.1 mm thick PTFE (Teflon™) coated fiberglass, available from Andrew Roberts Inc. (www.andrewroberts.com). Each of the flexible baffles had a flexible area of 2 cm×75 cm, and a horizontal spacing between each baffle was 2 cm. An air circulation means comprising a 20 cm diameter by 6 cm high-pressure blower driven by a 3450 RPM motor, both from Kooltronics™ model KBB58, (www.kooltronics.com) were used. The air heater comprised a 220V, 1500 W coil in each heating assembly. Thermal insulation comprised 25 mm Microsil™ from Zircar (www.zircar.com). A 0.4 mm aluminum plate was heated from 20 deg C. to 150 deg C. in approximately 10 seconds, with air temperature in the oven about 200 deg C. Overall dimensions of the oven (both heating assemblies) were 25 cm×30 cm×120 cm. Further the aluminum plate was not damaged or marked as it proceeded through the oven.

Embodiments of the invention can be used to heat the surfaces of many objects that can include, but are not limited to various forms of paper, film, plastics, laminates and printing plates. Further these objects may be in either sheet or continuous web form and may be conveyed in a substantially linear or curvilinear fashion within any heating means incorporating any of the preferred embodiments of the present invention. Other embodiments of the invention may be used to heat the surfaces of non-planar three-dimensional surfaces that can include but are not limited to rolls, printing cylinders and drums, printing sleeves. Additionally, an object such as a printing plate may be attached to a three dimensional forme such as a cylinder or sleeve and have its surfaces heated by an embodiment of the present invention.

In some embodiments of the invention, an object 3 may be supported on various support means as the surface of the object 3 is moved proximate to the flexible baffles of a given heating assembly. Such support means can include, but are not limited to, air-bearing plates, rolls, and conveyors. Further, planar objects may be supported by directly mounting the planar objects onto a support means comprising a cylinder. In such embodiments, the surface of the planar object is moved proximate to the baffles of a given heating assembly by a rotation of the cylinder. Obviously in some embodiments of the invention, the support means employed will be stationary with respect to the flexible baffles, while in other embodiments it will move relative to the flexible baffles.

Embodiments of the invention can be incorporated into a lithographic plate processing line. Embodiments of the invention may be used in a pre-heat oven wherein plates are thermally pre-sensitized prior to chemical processing. Pre-heat ovens according to the invention may be compact and are thus suitable as stand-alone devices or may be integral components of chemical processor units. Further, a pre-heat oven according to the invention can be made to have a short warm-up time. Such ovens may be incorporated in computer-to-plate (CTP) devices.

Ovens according to the invention may be used as or in post-bake ovens which may be provided to impart additional characteristics to processed printing plates. Again, some embodiments of the invention are compact. A post-bake oven comprising an embodiment of the invention can be a stand-alone unit or incorporated into the chemical process itself.

Embodiments of the invention can be used to heat many types of lithographic printing plates. These can include conventional printing plates that are exposed using a film mask. These can also include digital plates that are imaged in a CTP device. Such digital plates can include plates that comprise photopolymer coatings or thermal coatings. Although conventional and digital printing plates are typically used in sheet form, embodiments of the invention are not precluded from heating plate material that is in web form. Such embodiments of the invention are especially suitable for the manufacturing process of printing plates, wherein the plates undergo several heating cycles especially during the application of the photopolymer or thermal photosensitive coatings to the plate substrate.

There have thus been outlined the important features of the invention in order that it may be better understood, and in order that the present contribution to the art may be better appreciated. Those skilled in the art will appreciate that the conception on which this disclosure is based may readily be utilized as a basis for the design of other methods and apparatus for carrying out the several purposes of the invention. It is most important, therefore, that this disclosure be regarded as including such equivalent methods and apparatus as do not depart from the spirit and scope of the invention. Many alterations and modifications are possible in the practice of this invention without departing from the spirit or scope thereof. Accordingly, the scope of the invention is to be construed in accordance with the substance defined by the following claims.

1. A method for heating at least a first surface of an object, the method comprising:
a. moving the at least a first surface proximate to at least a first flexible baffle, the at least a first flexible baffle being:
i. in fluid communication with at least a first portion of a flow of air, and
ii. arranged to contact the at least a first surface in an absence of the flow of air;
b. pressuring and heating the flow of air; wherein the at least a first portion of the flow of air is operable for:
i. creating a first gap between the at least a first flexible baffle and at least a portion of the at least a first surface, and
c. conveying the at least a first portion of the flow of air through the first gap to heat the at least a portion of the at least a first surface.

2. The method of claim 1, wherein the object comprises at least a second surface, the method further comprising:
a. moving the at least a second surface proximate to at least a second flexible baffle, the at least a second flexible baffle being in fluid communication with at least a second portion of the flow of air, and arranged to contact the at least a second surface in the absence of the flow of air;
b. pressuring and heating the flow of air; wherein the at least a second portion of the flow of air is operable for:
i. creating a second gap between the at least a second flexible baffle and at least a portion of the at least a second surface, and
c. conveying the at least a second portion of the flow of air through the second gap to heat the at least a portion of the at least a second surface.

3. The method of claim 2, wherein the at least a first flexible baffle and the at least a second flexible baffle are further arranged wherein the at least a first flexible baffle contacts the at least a second flexible baffle in the absence of the flow of air.

4. The method of claim 2, wherein the at least a first flexible baffle comprises a first plurality of flexible baffles and the at least a second flexible baffle comprises a second plurality of flexible baffles, and wherein the first and second plurality of the flexible baffles are further arranged wherein a first member of the first plurality of flexible baffles contacts a first member of the second plurality of flexible baffles in the presence of the flow of air.

5. The method of claim 1, wherein the at least a first flexible baffle is further arranged to point in a direction of travel of the at least a first surface.

6. The method of claim 1, wherein the moving the at least a first surface proximate to the at least a first flexible baffle further comprises supporting the object on a support means during the moving.

7. The method of claim 6, wherein the at least a first flexible baffle is further arranged to contact the support means in the absence of the flow of air.

8. The method of claim 6, wherein the moving the at least a first surface proximate to the at least a first flexible baffle further comprises moving the support means.

9. The method of claim 6, wherein the moving the at least a first surface proximate to the at least a first flexible baffle further comprises not contacting the support means with the object during the moving.

10. The method of claim 1, wherein the moving the at least a first surface proximate to the at least a first flexible baffle comprises moving the at least a first surface along at least one of:
a. a substantially linear path, and
b. a substantially curved path.

11. The method of claim 1, wherein the at least a first flexible baffle comprises a first plurality of flexible baffles, and at least one member of the first plurality of flexible baffles is configured to be longer than at least one additional member of the first plurality of flexible baffles.

12. The method of claim 11, wherein the object comprises at least a second surface, the method further comprising:
a. moving the at least a second surface proximate to a second plurality of flexible baffles, wherein:
i. the second plurality of flexible baffles is in fluid communication with at least a second portion of the flow of air, and is arranged to contact the at least a second surface in the absence of the flow of air, and
ii. at least one member of the second plurality of flexible baffles is configured to be longer than at least one additional member of the second plurality of flexible baffles;
b. pressuring and heating the flow of air; wherein the at least second portion of the flow of air is operable for:
i. creating a second gap between the at the at least one member of the second plurality of flexible baffles and at least a portion of the at least a second surface, and
c. conveying the at least a second portion of the flow of air through the second gap to heat the at least a portion of the at least a second surface.

13. A method as in claim 1, further comprising recirculating and reusing the flow of air.

14. A method as in claim 13, comprising filtering the flow of air.

15. A method as in claim 13, further comprising conveying the flow of air through a catalytic converter.

16. An apparatus for heating at least a first surface of an object, the apparatus comprising:
a. means for moving the object, wherein the at least a first surface is moved proximate to at least a first flexible baffle, the at least a first flexible baffle being:
i. in fluid communication with at least a first portion of a flow of air, and
ii. arranged to contact the at least a first surface in an absence of the flow of air;
b. an air circulation means operable for creating and pressurizing the flow of air,
c. an air heating means operable for heating the flow of air, and
d. at least a first plenum operable for conveying the at least a first portion of the flow of air to the at least a first flexible baffle, wherein the at least a first portion of the flow of air is operable:
i. for creating a first gap between the at least a first flexible baffle and at least a portion of the at least a first surface, and
ii. heating the at least a portion of the at least a first surface.

17. The apparatus of claim 16, further comprising:
a. at least a second flexible baffle, the at least a second flexible baffle being:
i. in fluid communication with at least a second portion of the flow of air,
ii. arranged to contact at least a second surface of the object in the absence of the flow of air,
b. at least a second plenum operable for conveying the at least a second portion of the flow of air to the at least a second flexible baffle, wherein the at least a second portion of the flow of air is operable:
i. for creating a second gap between the at least a second flexible baffle and at least a portion of the at least a second surface, and
ii. heating the at least a portion of the at least a second surface.

18. The apparatus of claim 16, wherein the at least a first flexible baffle comprises a first plurality of flexible baffle, and wherein at least one member of the first plurality of flexible baffles is longer than at least one additional member of the first plurality of flexible baffles.

19. The apparatus of claim 17, wherein the at least a first flexible baffle comprises a first plurality of flexible baffles, and the at least a second flexible baffle comprises a second plurality of flexible baffles, and wherein:
a. at least one member of the first plurality of flexible baffles is longer than at least one additional member of the first plurality of flexible baffles, and
b. at least one member of the second plurality of flexible baffles is longer than at least one additional member of the second plurality of flexible baffles.

20. The apparatus of claim 16, wherein the at least a first flexible baffle comprises:
a. a first end portion; and
b. a second end portion; wherein the first end portion and the second end portion are affixed to at least one additional surface adjacent to the at least a first surface.

21. The apparatus of claim 16, further comprising at least a third plenum operable for recirculating and reusing the flow of air.

22. The apparatus of claim 16, further comprising an airflow filtration means.

23. The apparatus of claim 16, further comprising a catalytic converter.

24. The apparatus of claim 16, further comprising a systems controller operable for controlling at least one of:
a. the means for moving the object,
b. the air circulation means, and
c. the air heating means.

25. The apparatus of claim 16, wherein the object is a planar object.

26. The apparatus of claim 25, wherein the object is a printing plate.

27. The apparatus of claim 26, wherein the planar printing plate comprises one of:
a. a digital printing plate that has been imaged in a computer-to-plate device, and
b. a conventional printing plate that has been imaged through a film mask.

28. The apparatus of claim 25, wherein the object comprises one of:
a. a sheet of material, and
b. a web of material.

29. The apparatus of claim 16, wherein:
a. the object is cylindrical, and
b. the means for moving the object comprises means for rotating the object.

30. The apparatus of claim 29, wherein the cylinder comprises at least one of:
a. a printing cylinder,
b. a printing sleeve, and
c. a printing plate mounted on a cylinder.

31. The apparatus of claim 30, wherein the printing cylinder comprises at least one of:
a. a gravure printing cylinder,
b. an offset printing cylinder, and
c. a flexographic printing cylinder.

32. The apparatus of claim 16, further comprising a support means disposed to support the object.

33. The apparatus of claim 32, wherein the support means comprises an air bearing.

34. The apparatus of claim 16, wherein the apparatus is an oven.

35. The apparatus of claim 34, wherein the oven is one of:
a. a pre-heat oven, and
b. a post-bake oven.

36. Apparatus for heating a surface of an object, the apparatus comprising:
a flexible baffle having a tip projecting at least to a path;
a mechanism for moving the surface of the object along the path past the flexible baffle;
a source of heated pressurized air providing heated pressurized air on a first side of the baffle to provide a pressure differential across the baffle, the pressure differential sufficient, when the object is present, to deflect the tip of the baffle to clear the surface of the object and provide a thin layer of the heated pressurized air flowing between the tip of the baffle and the surface of the object in a direction from the first side of the baffle to a second side of the baffle.

37. Apparatus according to claim 36 wherein the tip of the flexible baffle projects past the path.

38. Apparatus according to claim 36 wherein the mechanism for moving the surface of the object moves the surface of the object in a direction from the first side of the baffle to the second side of the baffle.

39. Apparatus according to claim 38 wherein the baffle extends substantially transverse to the direction of motion of the object.

40. Apparatus according to claim 36 wherein the flexible baffle comprises a first one of a plurality of flexible baffles each having a tip projecting at least to the path, the source of heated pressurized air connected to provide heated pressurized air on a first side of each of the plurality of flexible baffles to provide a pressure differential across the baffle, the pressure differential sufficient, when the object is present, to deflect the tip of the baffle to clear the surface of the object and provide a thin layer of the heated pressurized air flowing between the tip of the baffle and the surface of the object in a direction from the first side of the baffle to a second side of the baffle.

41. Apparatus according to claim 36 wherein the surface of the object constitutes a first surface, the object has a second surface opposed to the first surface, and the apparatus comprises a second flexible baffle opposed to the first flexible baffle wherein the source of heated pressurized air provides heated pressurized air on a first side of the second baffle to provide a pressure differential across the second baffle, the pressure differential sufficient, when the object is present, to deflect the tip of the second baffle to clear the second surface of the object and provide a thin layer of the heated pressurized air flowing between the tip of the second baffle and the second surface of the object in a direction from the first side of the second baffle to a second side of the second baffle.

42. Apparatus according to claim 41 wherein tips of the first and second flexible baffles overlap one another in the absence of a the pressure differentials across the first and second baffles when the object is not present.

43. Apparatus according to claim 41 wherein:
the first flexible baffle constitutes one of a plurality of first flexible baffles each having a tip projecting at least to the path,
the second flexible baffle constitutes one of a plurality of second flexible baffles,
the source of heated pressurized air is connected to provide heated pressurized air on a first side of each of the plurality of first flexible baffles and on a first side of each of the plurality of second flexible baffles to provide a pressure differential across each baffle,
the pressure differential on each of the first plurality of baffles is sufficient, when the object is present, to deflect the tip of the baffle to clear the first surface of the object and provide a thin layer of the heated pressurized air flowing between the tip of the baffle and the surface of the object in a direction from the first side of the baffle to a second side of the baffle; and,
the pressure differential on each of the second plurality of baffles sufficient, when the object is present, to deflect the tip of the baffle to clear the second surface of the object and provide a thin layer of the heated pressurized air flowing between the tip of the baffle and the second surface of the object in a direction from the first side of the baffle to a second side of the baffle.

44. Apparatus according to claim 41 wherein the first and second baffles contact one another when the object is not present in the absence of the pressure differential.

45. Apparatus according to claim 36 wherein the surface of the object constitutes a first surface, the object has a second surface opposed to the first surface, and the apparatus comprises an air bearing supporting the second surface of the object.

46. A method for heating a surface of an object, the method comprising:
passing the surface of an object past a flexible baffle, the flexible baffle having a tip disposed to contact the surface of the object and blowing heated air between the tip of the baffle and the surface of the object, the heated air deflecting the tip of the baffle to clear the surface of the object and providing a thin layer heated air flowing between the tip of the baffle and the surface of the object.

47. A method according to claim 46 comprising passing the surface of the object sequentially past a series of flexible baffles, each having a tip disposed to contact the surface of the object and blowing heated air between the tip of each baffle and the surface of the object, the heated air deflecting the tip of the baffle to clear the surface of the object and providing a thin layer heated air flowing between the tip of the baffle and the surface of the object.

48. A method according to claim 46 wherein the surface of the object constitutes a first surface, the object has a second surface opposed to the first surface, and the method comprises providing at least one second baffle having a tip disposed to contact the second surface of the object and blowing heated air between the tip of the at least one second baffle and the second surface of the object, the heated air deflecting the tip of the at least one second baffle to clear the second surface of the object and providing a thin layer heated air flowing between the tip of the at least one second baffle and the surface of the object.

49. A method according to claim 48 wherein the at least one second baffle comprises a plurality of second baffles.

50. A method according to claim 46 wherein the surface of the object constitutes a first surface, the object has a second surface opposed to the first surface, and the method comprises supporting the second surface of the object on an air bearing while passing the surface of the object past the baffle.
